(19) United States
(12) Patent Application Publication
(10) Pub. No.: US 2025/0217410 A1
(43) Pub. Date: Jul. 3, 2025

(54) INFORMATION COMMUNICATION TERMINAL DEVICE SUITED TO INFORMATION SEARCH SERVICES, METHOD FOR CONTROLLING DISPLAY IN SAID DEVICE, AND COMPUTER PROGRAM FOR EXECUTING SAID METHOD

(71) Applicant: DEARWONDER INC., Tokyo (JP)

(72) Inventors: Yoshiaki SAKITO, Tokyo (JP); Naoya KUWAJIMA, Tokyo (JP)

(73) Assignee: DEARWONDER INC., Tokyo (JP)

(21) Appl. No.: 18/848,049

(22) PCT Filed: Mar. 3, 2023
(86) PCT No.: PCT/JP2023/008194

§ 371 Date: Sep. 17, 2024

(30) Foreign Application Priority Data
Mar. 18, 2022 (JP) 2022-044379

(51) Int. Cl. G06F 16/538; G06F 3/04845; G06F 3/04883; G06V 30/19; G06V 30/22

(52) U.S. Cl. CPC G06F 16/538; G06F 3/04845; G06F 3/04883; G06V 30/19; G06V 30/22

(57) ABSTRACT

The present invention is an information communication terminal device that is communicably connectable to a search server. The information communication terminal device comprises: a user interface unit that includes a touch panel; a search query acquisition unit that acquires a search query; a search result acquisition unit that acquires search results containing multiple search result images transmitted from the search server in response to the search query; and a display control unit that performs control for displaying each of the multiple search result images contained in the search results on a screen that represents a virtual space on the touch panel. The display control unit performs control such that each of the multiple search result images is displayed in animated form in sequence with a visually recognizable time difference.

### TECHNICAL FIELD

The present invention relates to an information communication terminal device suited to information search services, a method for controlling display in such device, and a computer program for executing such method.

### BACKGROUND ART

A so-called Internet search is an information search service on a website for searching vast amounts of information (resources) distributed on the Internet. Typically, in such Internet searches, a server program called a search engine on the service provider's website performs an index search based on a search query given by a user and provides the search results to the user. For example, when a user accesses a search site through a web browser and enters, as a search query, characters or character strings related to the resource the user wants to search, the search engine analyzes the search query, searches for the indices, scores the extracted resources based on a predetermined ranking algorithm, sorts them in scoring order, and provides the list to the user as search results.

In such Internet searches, the user can search not only for text data but also for multimedia data such as image data. In image searches, the search results are typically displayed on the browser as a list of reduced images, but as another display mode, for example, a technique such as that in Patent Document 1 below has been proposed.

Specifically, Patent Document 1 below discloses a technique in which, in addition to displaying response results with respect to a search query, response results with respect to related queries are also displayed. In addition, Patent Document 1 discloses a technique in which these results are ordered along a plurality of display axes, including at least one axis corresponding to the ordering of the various search queries, and the results are displayed in an aligned manner or in a non-aligned manner. Further, Patent Document 1 discloses a technique in which the results can be translated along one or more of the display axes so that the user can browse through the various results.

### PRIOR ART DOCUMENTS

### Patent Documents

Patent Document 1: Japanese Unexamined Patent Application Publication (Translation of PCT Application) No. 2013-544406

### SUMMARY OF THE INVENTION

### Problems to be Solved By The Invention

Many people often work while recording ideas they come up with on paper media, such as a memo pad or a notebook, or, recently, in electronic media, such as on tablet computers. In particular, designers and creators, who engage in creative activities, sometimes make use of Internet searches in expectation of finding some kind of inspiration, and repeatedly record ideas obtained from search results on various media.

In this kind of human creative activity, a movement of switching from a pen (stylus) that the user is currently holding to a mouse or typing on the keyboard to perform search on the Internet can disrupt the thought process, and this interferes with a seamless thought process. In addition, because tablet computers are provided with a so-called software keyboard, it is possible for users to enter keystrokes while using a pen, but this is still not enough to materialize a seamless thought process from the viewpoint of usability.

Moreover, the current image search simply provides a list of extracted images displayed on the browser, and no consideration has been made with respect to evoking people's thoughts and promoting the activation of such thoughts. While the technique disclosed in Patent Document 1 can display, in addition to the images resulting from the search query, the images resulting from the related queries in an aligned manner or in a non-aligned manner, it does not take into account the materialization of a seamless thought process and/or the promotion of the evocation and activation of thoughts.

The response or sensation that a person feels by the stimuli to the auditory and/or visual senses, such as comfort, or a pleasing sensation in the brain, is known as Autonomous Sensory Meridian Response (ASMR). Therefore, the stimuli to the auditory and/or visual senses that make people feel comfortable are considered to be effective in evoking and activating people's thoughts.

Accordingly, an object of the present invention is to provide: an information communication terminal device which allows a user to materialize a seamless thought process and which allows for the promotion of the evocation and activation of thoughts; and a method for controlling display by means of such device.

More specifically, one of the objects of the invention is to provide: an information communication terminal device which prevents the thought process from being interrupted and allows a seamless thought process to be materialized by realizing, in an information search service, the flow from the entry of a search query to the display of search results with a flow of a sequence of smooth user operations; and a method for controlling display by means of such device.

Another object of the present invention is to provide: an information communication terminal device that can promote the evocation and activation of thoughts by displaying search results with respect to a search query in a mode that can make the user feel comfortable; and a method for controlling display by means of such device.

### Means for Solving the Problems

The present invention for solving the above-described problems is configured to include the matters specifying the invention or technical features indicated below.

The present invention according to an aspect is an information communication terminal device that is communicably connectable to a search server. The information communication terminal device may comprise: a user interface unit that includes a touch panel; a search query acquisition unit that acquires a search query; a search result acquisition unit that acquires search results containing multiple search result images transmitted from the search server in response to the search query; and a display control unit that performs control for displaying each of the multiple search result images contained in the search results on a screen that represents a virtual space on the touch panel. The display control unit may perform control such that each of the multiple search result images is displayed in animated form in sequence with a visually recognizable time difference.

The information communication terminal device may further comprise a recognition unit that performs first recognition processing based on line drawing data handwritten on the screen of the touch panel. The search query acquisition unit may acquire a text (keyword) recognized by the recognition unit as the search query.

The recognition unit starts performing the first recognition processing in response to a user's first manipulation action to the line drawing data on the screen of the touch panel.

Here, the first manipulation action may be a drawing of a line that encloses at least part of an area indicated by the line drawing data on the screen of the touch panel.

In addition, the recognition unit may be configured to perform second recognition processing on image data to generate object information. Then, the search query acquisition unit may acquire the search query based on the generated object information.

In addition, the display control unit may perform control of the display in animated form such that each of the multiple search result images gradually appears from a first position determined with respect to the search result image on the screen of the touch panel.

The mode of the display in animated form may be at least one of: a mode in which the search result image is gradually completed visually; a mode in which the search result image is visually expressed in perspective; and a mode in which the search result image is visually enhanced.

In addition, the display control unit may determine the first position on the screen for each of the multiple search result images and perform control such that each search result image is displayed at the determined first position.

The first positions for the respective search result images are not geometrically aligned with each other. That is, the display control unit may randomly determine the first position for each search result image.

In addition, the display control unit performs control of the display in animated form such that the displayed search result image gradually disappears after a predetermined period of time has elapsed.

In addition, the display control unit may perform control, in response to the user's second manipulation action on at least one search result image of interest from among the multiple search result images on the screen of the touch panel, so as to move the at least one search result image of interest to a second position on the screen.

In addition, the search query acquisition unit may acquire, in response to the user's second manipulation action on at least one search result image of interest from among the multiple search result images on the screen of the touch panel, a new search query based on metadata associated with the at least one search result image of interest.

In addition, the display control unit may perform control, in response to the user's second manipulation action on at least one search result image of interest from among the multiple search result images on the screen of the touch panel, so as to highlight the at least one search result image of interest.

In addition, the search query acquisition unit may acquire a new search query based on metadata associated with the at least one search result image of interest, if the user chooses to perform a search.

In addition, the display control unit may perform control, in response to the second manipulation action, such that the display in animated form is achieved in which the speed with which each of the multiple search result images gradually appears is increased.

In addition, the display control unit may perform control, in response to the user's third manipulation action on at least one search result image of no interest from among the multiple search result images on the screen of the touch panel, so as to remove the at least one search result image of no interest from the screen.

In addition, the search query acquisition unit may acquire, in response to the third manipulation action, a new search query based on metadata associated with some search result images devoid of the at least one search result image of no interest from among the multiple search result images.

The present invention according to another aspect is a method of displaying search results by an information communication terminal device communicably connectable to a search server. The method may comprise: acquiring a search query from a user's input to a touch panel of the information communication terminal device; in response to the search query, acquiring search results containing multiple search result images transmitted from the search server; and performing display control for displaying each of the multiple search result images contained in the search results on a screen representing a virtual space on the touch panel of the information communication terminal device. The performing display control may include performing control so as to display each of the multiple search result images in animated form in sequence with a visually recognizable time difference.

Further, the present invention according to another aspect may relate to: a computer program for causing an information communication terminal device to implement a method for displaying search results transmitted from a search server in response to a search query; and a computer readable recording medium in which such computer program is recorded in a non-transitory manner.

In the present disclosure, the term “means” or “unit” does not merely mean a physical means but also encompasses the case where the functions of such means or unit are partially or entirely implemented by software. In addition, a function of one means or unit may be implemented by two or more physical means, and functions of two or more means or units may be implemented by one physical means.

Further, in the present disclosure, the term “system” includes an ensemble where multiple apparatuses (or functional modules implementing specific functions) are logically assembled, regardless of whether each apparatus or functional module is physically configured as a single entity or as a separate entity.

### EFFECT OF THE INVENTION

According to the present invention, a user can materialize a seamless thought process and the evocation and activation of thoughts can be promoted.

In addition, according to the present invention, in an information search service, the flow from the entry of a search query to the display of search results can be realized with a flow of a sequence of smooth operations. In this way, the user can be prevented from being interrupted in the thought process, and a seamless thought process can be materialized.

Further, according to the present invention, the search results with respect to a search query can be displayed in a mode that makes the user feel comfortable. In this way, the evocation and activation of the user's thoughts are promoted, thereby allowing him/her to engage in more creative activities.

Other technical features, objects, and effects or advantages of the present invention will become apparent by the following embodiments described with reference to the attached drawings.

### BRIEF DESCRIPTION OF THE DRAWINGS

FIG. 1 is a diagram for describing an example of a schematic configuration of a creation assistance system according to an embodiment of the present invention.

FIG. 2 is a diagram showing an example of a hardware configuration of an information communication terminal device according to an embodiment of the present invention.

FIG. 3 is a diagram showing an example of content in a memory module of an information communication terminal device according to an embodiment of the present invention.

FIG. 4 is a block diagram showing an example of a functional configuration model of an information communication terminal device according to an embodiment of the present invention.

FIG. 5 is a flowchart showing an example of processing performed by an information communication terminal device according to an embodiment of the present invention.

FIG. 6 is a flowchart showing an example of processing a handwriting input performed by an information communication terminal device according to an embodiment of the present invention.

FIG. 7 is a flowchart showing an example of search processing performed by an information communication terminal device according to an embodiment of the present invention.

FIG. 8 is a flowchart showing an example of display processing of search results performed by an information communication terminal device according to an embodiment of the present invention.

FIG. 9 is a flowchart showing an example of processing for displaying in animated form performed by an information communication terminal device according to an embodiment of the present invention.

FIG. 10 is a flowchart showing an example of processing for selecting an object performed by an information communication terminal device according to an embodiment of the present invention.

FIG. 11 is a flowchart showing an example of processing for moving an object performed by an information communication terminal device according to an embodiment of the present invention.

FIG. 12 is a flowchart showing an example of processing for removing an object performed by an information communication terminal device according to an embodiment of the present invention.

FIG. 13 is a diagram showing an example of a screen on a touch panel of an information communication terminal device according to an embodiment of the present invention.

FIG. 14 is a diagram showing an example of a screen on a touch panel of an information communication terminal device according to an embodiment of the present invention.

FIG. 15 is a diagram showing an example of a screen on a touch panel of an information communication terminal device according to an embodiment of the present invention.

FIG. 16 is a diagram showing an example of a screen on a touch panel of an information communication terminal device according to an embodiment of the present invention.

FIG. 17 is a diagram showing an example of a screen on a touch panel of an information communication terminal device according to an embodiment of the present invention.

FIG. 18 is a diagram showing an example of a screen on a touch panel of an information communication terminal device according to an embodiment of the present invention.

FIG. 19 is a flowchart showing another example of processing for selecting an object performed by an information communication terminal device according to an embodiment of the present invention.

FIG. 20 is a diagram showing another example of a screen on a touch panel of an information communication terminal device according to an embodiment of the present invention.

### DESCRIPTION OF THE EMBODIMENTS

Embodiments of the present invention will be described below with reference to the drawings. However, the embodiments described below are only illustrations, and there is no intention to exclude the application of various variations or technologies not expressly stated below. The present invention may be implemented with various variations (such as by combining each embodiment) without departing from its spirit. In addition, the same or similar parts will be denoted with the same or similar references in the following descriptions of the drawings. The drawings are schematic and do not necessarily correspond to the actual dimensions or ratios. Parts may also be included wherein the dimensional relationship or ratio between each other is different among the drawings.

### Overall System

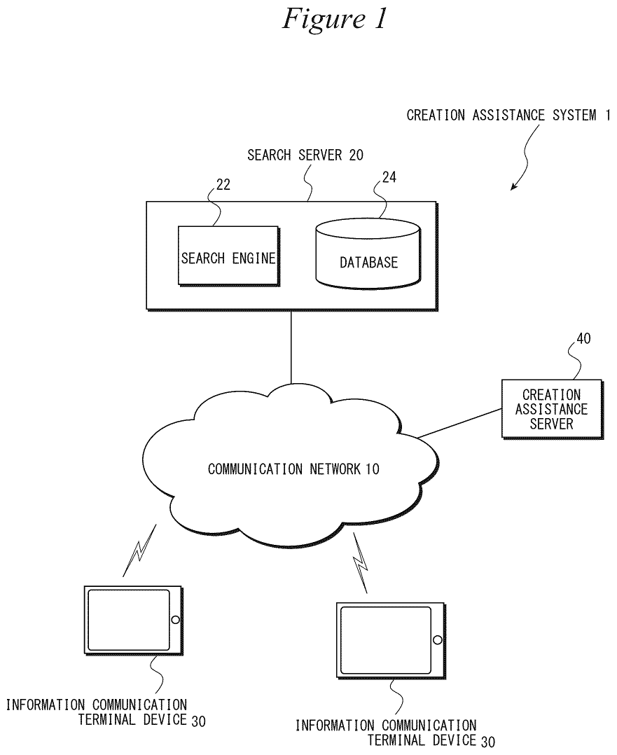

FIG. 1 is a diagram for describing an example of a schematic configuration of a creation assistance system according to an embodiment of the present invention. As shown in FIG. 1, the creation assistance system 1 of the present embodiment is configured to include a search server 20 and an information communication terminal device 30 that are communicably interconnected via, for example, a communication network 10. The search server 20 and the information communication terminal device 30 constitute a server/client model that realizes an information search system. In addition, the creation assistance system 1 may include a creation assistance server 40.

The communication network 10 may include, for example, an IP-based computer network (hereinafter referred to as an “IP network”). In the present disclosure, the communication network 10 is used in a broad concept to include the Internet constructed by IP networks, but it is not limited to such IP networks and is not intended to exclude networks of other protocols that allow for communication between nodes. In addition, the communication network 10 may include wireless networks (e.g., Wi-Fi (registered trademark), etc.) constructed by wireless base stations or wireless access points that are not shown. In addition, the communication network 10 may include a mobile communication network that conforms to the mobile communication system standards.

The search server 20 is a computing device that provides information search services to users. The search server 20 comprises, for example, a search engine 22 and a database 24. Although not shown, the search server 20 may include a crawler that functions as a robot agent. The crawler periodically visits web pages on the Internet, collects and analyzes information on the web pages visited, and creates an index for referencing and searching the database 24. Based on the search query received from the user's information communication terminal device 30, the search server 20 performs an index search through the search engine 22, extracts relevant resources from the database 24, and transmits them to the information communication terminal device 30. The search engine 22 may be configured to perform searches by performing machine inference that is based, for example, on search queries and/or search history. In the present disclosure, the resources that are to be extracted with respect to the search query are images. Images may include still images and moving images. The web site (search site) provided by the search server 20 may be any web site that is accessible to the user by means of the information communication terminal device 30, and it may be a known search site on the Internet.

The information communication terminal device 30 is a computing device manipulated by a user, and is typically, without limitation, a tablet computer, or similar computer, but it may be any device configured so that the present invention can be realized. In the present example, the information communication terminal device 30 is a tablet computer that allows for interactive manipulations via a touch panel or touch screen. The information communication terminal device 30 implements a creative assistance program that realizes a user interface environment that effectively allows the user to exert his/her creative ability, as described below.

The creation assistance server 40 is a computing device that functions as, for example, a cloud server for the information communication terminal device 30. The creation assistance server 40 manages, for example, the accounts of the user who manipulates the information communication terminal device 30. In addition, the creation assistance server 40 may store the user's predetermined manipulation actions performed on the information communication terminal device 30 and the sequence of processing processes corresponding to these actions as an operation history.

### Hardware Configuration of Information Communication Terminal Device

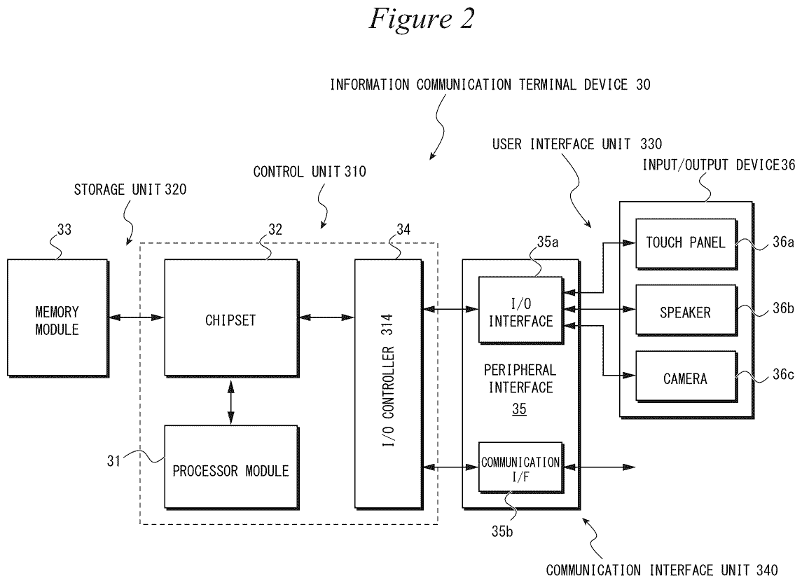

FIG. 2 is a diagram showing an example of a hardware configuration of an information communication terminal device suited to a creation assistance system according to an embodiment of the present invention. FIG. 2 shows those hardware resources that are of particular relevance to the present invention from among various hardware resources configuring the information communication terminal device 30.

Specifically, as shown in FIG. 2, the information communication terminal device 30 may typically be configured to include one or more processor modules 31, a chipset 32, a memory module 33, an I/O controller 34, various peripheral interfaces 35, and various input/output devices 36 (a touch panel 36a, etc.).

The processor module 31 includes, for example, a processor (processor core), a microcontroller, a digital signal processor, and/or a combination thereof, but the processor module is not limited thereto. The chipset 32 consists of a circuit on which bridges for the buses connecting the processor module 31, the memory module 33, and the I/O controller 34, or similar components and other components necessary for configuring the information communication terminal apparatus 30 are integrated. The chipset 32 is controlled by, for example, the processor module 31. In the present disclosure, the processor module 31 may be simply referred to as a “processor”.

The memory module 33 is a primary storage device consisting of volatile memory (e.g., RAM), non-volatile memory (e.g., ROM, flash memory, etc.), and/or a combination thereof, and to be used by the processor module 31. The memory module 33 may include video memory (VRAM) for the touch panel 36a. In the present disclosure, the memory module 33 may be simply referred to as “memory”.

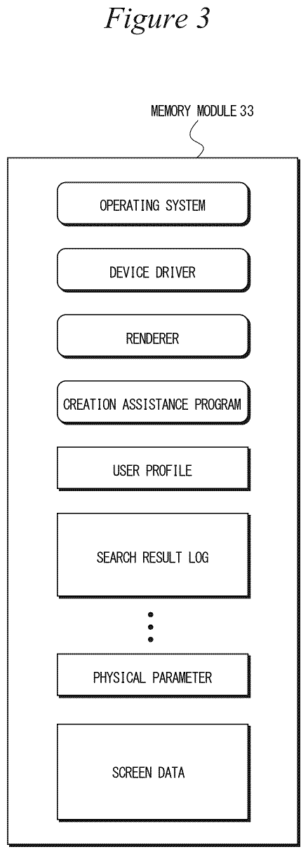

For example, as shown in FIG. 3, the memory module 33 holds various software resources, i.e., device drivers, operating system (OS) programs, one or more application programs, and various types of data, or the like. In the present disclosure, the application programs include a creation assistance program that is executed on the OS of the information communication terminal device 30 under the control of the processor module 31. Under the control of the processor module 31, the creation assistance program causes the information communication terminal device 30 to realize a user interface environment that effectively allows the user to exert his/her creative ability. Some processing in the creative assistance program may be executed as different threads or processes on the processor module 31. In addition, the various types of data include, for example, image data (still image data and moving image data). The various types of data are stored as image files, for example, in image folders logically structured on the memory module 33.

The I/O controller 34 is a circuit that controls data transfer between various peripheral interfaces 35 (e.g., an I/O interface 35a and a communication interface 35b, etc.). The I/O interface 35a controls the operation of the input/output device 36 configuring the user interface. The communication interface 35b is a circuit that allows for computer communication via the IP network 10.

The input/output device 36 is configured to include, for example, a touch panel 36a, a speaker 36b, a camera 36c, and similar components. In addition, although not shown, the input/output device 36 may include a microphone for voice input.

The touch panel 36a is configured to include: a display for displaying text data, image data (still image data and moving image data), and multimedia data, such as graphic data and similar data; and a transparent touch sensor sized so as to approximately match the size of the display. The touch panel 36a is an example of a device that realizes the user interface environment. The input/output device 36 may be configured to include a display and a touch-pad configured separately from the display, instead of the touch panel 36a. Under the control of the processor module 31, the touch panel 36a displays various screens on the display and accepts interactive manipulations from the user. The user can provide various inputs to the touch panel 36a, such as by means of manipulation actions using a pen (stylus) or finger.

The speaker 36b outputs audio or sound based on audio signals generated by a sound driver (not shown). Under the control of the processor module 31, the speaker 36b may read out text data or output music and/or sound effects, and the like.

The camera 36c generates image data by means of image elements under the control of the processor module 31. The image data generated by the camera 36c is stored in the memory module 33 as image files. In the present disclosure, in such image files, object information (e.g., name, etc.) is generated through image recognition processing and converted into search queries based on such object information.

### Functional Configuration Model of Information Communication Terminal Device

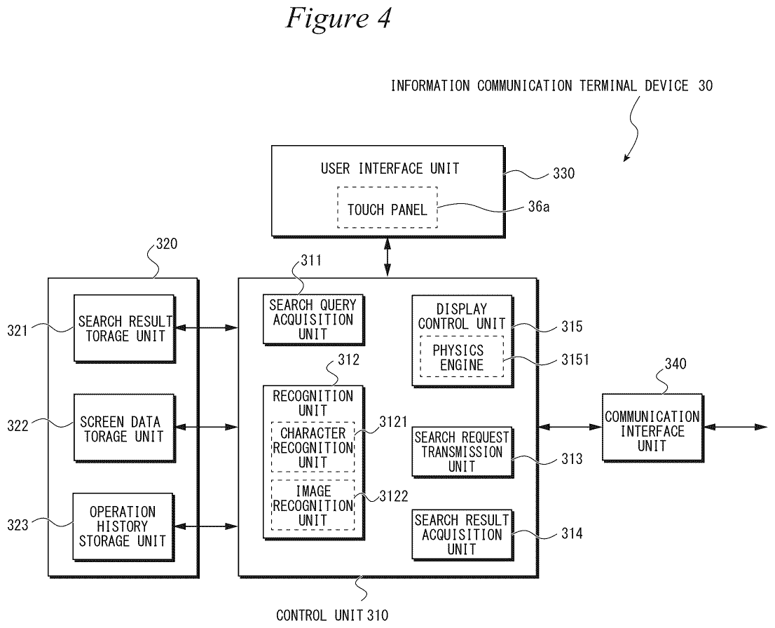

FIG. 4 is a block diagram showing an example of a functional configuration model of an information communication terminal device according to an embodiment of the present invention. In FIG. 4, the information communication terminal device 30 is configured as a functional configuration model configured to include, for example, a control unit 310, a storage unit 320, a user interface unit 330, and a communication interface unit 340. Such functional configuration model is realized in cooperation with the aforementioned various software and/or hardware resources by executing the creation assistance program under the control of the processor module 31.

The control unit 310 comprehensively controls and executes various types of processing (tasks) in the information communication terminal device 30. In the present example, the control unit 310 is configured to include a search query acquisition unit 311, a recognition unit 312, a search request transmission unit 313, a search result acquisition unit 314, and a display control unit 315. The details of the functional configuration of these components in the control unit 310 will be described below.

The storage unit 320 may include a search result storage unit 321, a screen data storage unit 322, and an operation history storage unit 323.

The search result storage unit 321 stores the search results acquired from the search server 20 under the control of the control unit 310. In the present disclosure, the search results include one or more images. An image is an image file that conforms to a predetermined image format (e.g., JPEG, PNG, WebP, etc.) and the image is associated with metadata. The image file may include metadata as part of itself. Examples of metadata include, without limitation, text data, and similar data, indicating, for example, the URL of the image or its name. In the present disclosure, images acquired as search results are sometimes referred to as “search result images”. In addition, the search result storage unit 321 may include a storage area to save the search result image selected by the user. For example, the search result storage unit 321 may save the search result image file selected by the user in an asset folder under the control of the control unit 310.

The screen data storage unit 322 stores data (hereinafter referred to as “screen data”) for representing the image provided by the user interface unit 330 as a virtual space, under the control of the control unit 310. The screen data may include objects, coordinate information thereof, and similar information. In the present disclosure, an object may be a mark or element displayed on a screen, including, for example, a search result image, an icon, a line drawing, and the like. The screen data stored in the screen data storage unit 322 is rendered by the control unit 310 (e.g., a renderer) and passed to the user interface unit 330, which displays the rendered screen image as a screen containing objects on the touch panel 36a.

The operation history storage unit 323 stores: predetermined manipulation actions accepted through the touch panel 36a; and the sequence of processing processes performed by the control unit 310 and the results thereof corresponding to these actions, as an operation history, under the control of the control unit 310. Such operation history may also be held on the creation assistance server 40 under the control of the control unit 310.

The user interface unit 330 provides the user with an interactive manipulation environment via the touch panel 36a, and the like. Specifically, the user interface unit 330 displays a screen representing the virtual space on the touch panel 36a and accepts various manipulation actions made by the user to the screen. The user may enter a manipulation action using, for example, a pen.

As an example, the user interface unit 330 may provide a screen by means of which a handwriting input by the user is accepted and on which line drawings are displayed according to such input. The information entered by the handwriting input may be, for example, a character or character string (text), and/or a line drawing showing a closed curve, and the like. As another example, the user interface unit 330 may provide a screen in which objects are displayed in animated form under the control of the control unit 310. As a further example, the user interface unit 330 may accept the user's manipulation action on the objects. Examples of the manipulation actions on the objects include a tap (single tap, double tap, etc.), a drag, a flick, a swipe, and the like, but the manipulation actions are not limited thereto.

The communication interface unit 340 controls communication such that the information communication terminal device 30 can access the search server 20 through the communication network 10. For example, the communication interface unit 340 may perform control so as to transmit a search request based on the search query to the search server 20 under the control of the control unit 310. In addition, the communication interface unit 340 may receive the search results transmitted from the search server 20 in response to the search query of the search request, and pass them to the control unit 310.

Next, the details of the functional configuration of the control unit 310 will be described.

The search query acquisition unit 311 acquires the search queries for the search server 20 from various channels. As an example, the search query acquisition unit 311 identifies the line drawing in the screen data according to the user's predetermined manipulation action on the touch panel 36a, and acquires, as a search query, the results which are character-recognized by the recognition unit 312 based on the data related to the line drawing (line drawing data). More specifically, if the user, as a predetermined manipulation action, moves a pen so as to enclose at least part of the area of the screen showing line drawing data displayed on the touch panel 36a while keeping the pen in contact with the touch panel 36a, the search query acquisition unit 311 identifies the line drawing data enclosed by the trajectory of the movement of the pen, passes the identified line drawing data to the recognition unit 312, acquires text data output from the recognition unit 312 in response to the passed identified line drawing data, and sets the text data as a search query. The manipulation action of the user moving the pen so as to enclose at least part of the area showing the line drawing is one mode of a first manipulation action. In addition, in this case, a sequence of manipulation actions of the user moving the pen so as to enclose at least part of the area showing the line drawing and then performing an additional gesture (e.g., a check operation) may also be considered as the first manipulation action. Alternatively, the manipulation action of the user tapping (e.g., double-tapping) or long pressing in the vicinity of the line drawing on the screen displayed on the touch panel 36a may also be considered as the first manipulation action.

As another example, the search query acquisition unit 311 may identify an object in the screen data according to the user's predetermined manipulation action on the touch panel 36a, and acquire the metadata associated with the object as a search query. For example, a manipulation action, such as the user tapping on an object of interest (search result image) on the screen displayed on the touch panel 36a, may be one mode of a second manipulation action. Alternatively, a manipulation action, such as flicking the search result image that the user wants to exclude (i.e., of no interest) from among the multiple search result images on the screen displayed on the touch panel 36a, may be one mode of a third manipulation action. In response to the third manipulation action, the search query acquisition unit 311 acquires a new search query based on the metadata associated with the search result images devoid of the excluded search result image among the multiple search result images.

As another example, the search query acquisition unit 311 may select any object in the screen data at an arbitrary timing and acquires the metadata associated with that object as a search query.

The recognition unit 312 performs predetermined recognition processing on various objects on the screen displayed on the touch panel 36a to generate and output text data. In the present disclosure, the recognition unit 312 is configured to include a character recognition unit 3121 and an image recognition unit 3122. The recognition unit 312 may include a voice recognition unit (not shown) that performs voice recognition processing to generate text data. The search query acquisition unit 311 may acquire the search query based on the text data obtained by the voice recognition processing.

The character recognition unit 3121 analyzes the line drawing data using a predetermined character recognition algorithm to generate and output the text data that the line drawing data may be indicating (first recognition processing). The character recognition unit 3121 may be configured to have the function of matching the generated text data with a dictionary database (not shown) and converting the generated text data into words present in the dictionary database. As a result, even if the line drawing data is scribbled, what the user originally intended can still be obtained as a result of character recognition.

The image recognition unit 3122 analyzes image data, such as photographs, using a predetermined image recognition algorithm, extracts or recognizes objects that the image data may be indicating, and outputs the object information thereof (name, etc.) as text data (second recognition processing). For example, if the image data is a landscape photograph capturing a bridge where automobiles come and go, the image recognition unit 3122 may recognize “automobiles” and a “bridge” therefrom, and may generate and output text data indicating the names thereof. For example, the image recognition unit 3122 may generate object information by performing image recognition processing on the image data, such as photographs, which are read out from the image folder by the user.

In the present example, the recognition unit 312 is described as being configured in the control unit 310, but the configuration is not limited thereto, and some or all of the recognition unit 312 may be configured on an external cloud server (e.g., the creation assistance server 40), and the recognition results may be acquired through the communication interface unit 340.

The recognition unit 312 may also output multiple candidates of the recognition results instead of uniquely outputting recognition results. The user may select the desired one from several candidates of the recognition results displayed on the screen of the touch panel 36a.

The search request transmission unit 313 generates and outputs a search request based on the search query acquired by the search query acquisition unit 311. The search request output from the search request transmission unit 313 is transmitted to the search server 20 through the communication interface unit 340.

The search result acquisition unit 314 receives and acquires the search results transmitted from the search server 20, in response to the search request, through the communication interface unit 340. For example, the search result acquisition unit 314 may divide the multiple search result images searched and extracted by the search server 20 into a predetermined number and acquire them as search results. The search result acquisition unit 314 passes the search results including the acquired search result images to the display control unit 315. The search result acquisition unit 314 also stores the search results in the search result storage unit 321.

The display control unit 315 controls the display of the screen representing the virtual space on the touch panel 36a. For example, the display control unit 315 may perform control, by responding to the user's handwriting input to the screen displayed on the touch panel 36a, so as to display the trajectory thereof on the screen.

For example, the display control unit 315 may also perform control so that multiple search result images acquired by the search result acquisition unit 314 are displayed in animated form on the screen of the touch panel 36a. More specifically, the display control unit 315 displays each of the multiple search result images in animated form such that they appear in sequence at arbitrary positions on the screen with a visually recognizable time difference. The display control unit 315 may randomly determine the appearance position (first position) on the screen for each search result image. Therefore, the appearance positions of the respective search result images are not geometrically aligned with each other. An example of displaying in animated form in which the search result images are caused to appear on the screen may include a mode in which the search result images are gradually completed from a visually empty or blurry state. Another example may be a mode in which the search result images are expressed as if they are moving in the virtual space. The mode in which the search result images are expressed as if they are moving in the virtual space may include a mode in which the search result images are expressed as if they are visually approaching in terms of perspective. As a further example, there may be a mode in which the search result images are visually enhanced.

The display control unit 315 may also include a physics engine 3151. The physics engine 3151 simulates the behavior of objects (e.g., search result images) in a virtual space by performing physics calculations according to predetermined physical parameters. Examples of the predetermined physical parameters may include mass, velocity, external force, fluid velocity, and similar parameters. As an example, the physics engine 3151 may simulate the behavior of a search result image in the virtual space by using a metaphor of the behavior of fire sparks floating in the air in a bonfire. As another example, the physics engine 3151 may simulate the behavior of a search result image in the virtual space by using a metaphor of bubbles rising out of water. As a result, in addition to or as an alternative to the above-described display in animated form, the display control unit 315 allows the search result images to be displayed in animated form on the screen as if they float in the virtual space. Such display of the search result images in animated form allows the user to feel comfort, and evocation and activation of thoughts are promoted, thereby allowing for more creative activities.

The physics engine 3151 may also perform simulations such that the fluctuation of a search result image floating in the virtual space is a 1/f fluctuation. The 1/f fluctuation is a fluctuation in which the power spectral density is inversely proportional to the frequency f (where f>0). By the display in animated form that expresses the behavior of the search result image with such 1/f fluctuation allows for the user to stabilize their mind and engage in even more creative activities by resonating with their own biological rhythms.

The display control unit 315 also removes the search result image from the screen by controlling the display in animated form as if the search result image disappears (fades out) gradually or spontaneously when the display of the search result image in animated form has elapsed a predetermined period of time (e.g., 10 seconds). As a result, there is no overflow of the search result images on the screen, and an appropriate number of search result images are displayed in animated form, which prevents the user's thought process from being disturbed. However, even if the search result image is removed from the screen, it may still remain stored in the search result storage unit 321 without being removed therefrom.

### Processing in Information Communication Terminal Device

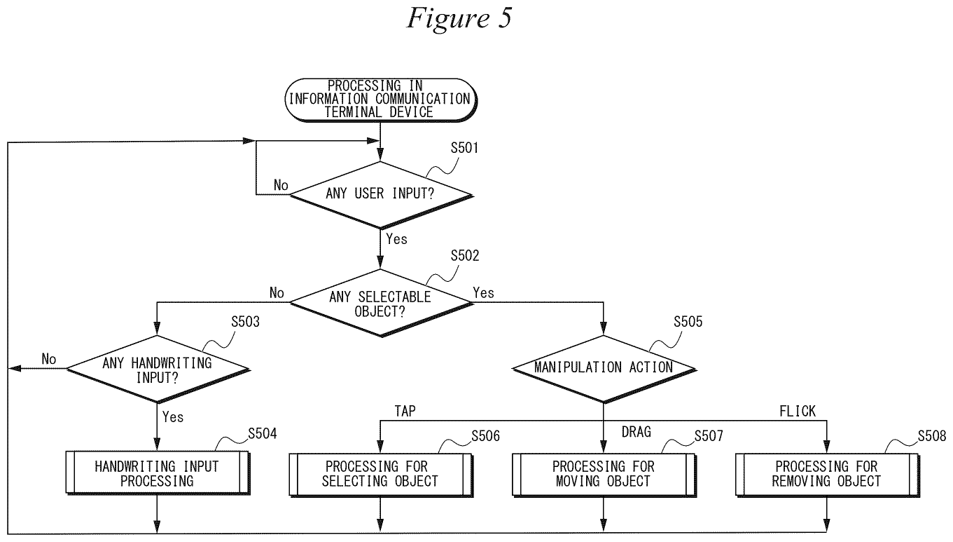

FIG. 5 is a flowchart showing an example of processing performed by an information communication terminal device according to an embodiment of the present invention. Such processing may be achieved by the information communication terminal device 30 executing the creation assistance program, under the control of the processor module 31, in cooperation with various software resources and/or hardware resources. FIG. 5 describes the processing flow according to the user's manipulation actions on the information communication terminal device 30 that executes the creation assistance program.

Specifically, when the control unit 310 of the information communication terminal device 30 starts executing the creation assistance program, the control unit 310 displays a screen, as a user interface environment, for the creation assistance to the user on the touch panel 36a, and monitors whether the user has made any input (manipulation action) to the screen (S501).

If the control unit 310 determines that the user has made a manipulation action to the screen (S501; Yes), then the control unit 310 determines whether there is a selectable object at a position on the screen corresponding to the manipulation action (S502). In other words, the control unit 310 determines whether the user is making an input to a free area (an area where nothing is drawn) on the screen of the touch panel 36a.

If the control unit 310 determines that there is no selectable object at the position on the screen corresponding to the user's manipulation action (S502; No), then the control unit 310 determines whether the user's manipulation action is a handwriting input (S503). The handwriting input is an operation consisting of a combination of one or more strokes in which the user moves the pen in physical contact with the touch panel 36a.

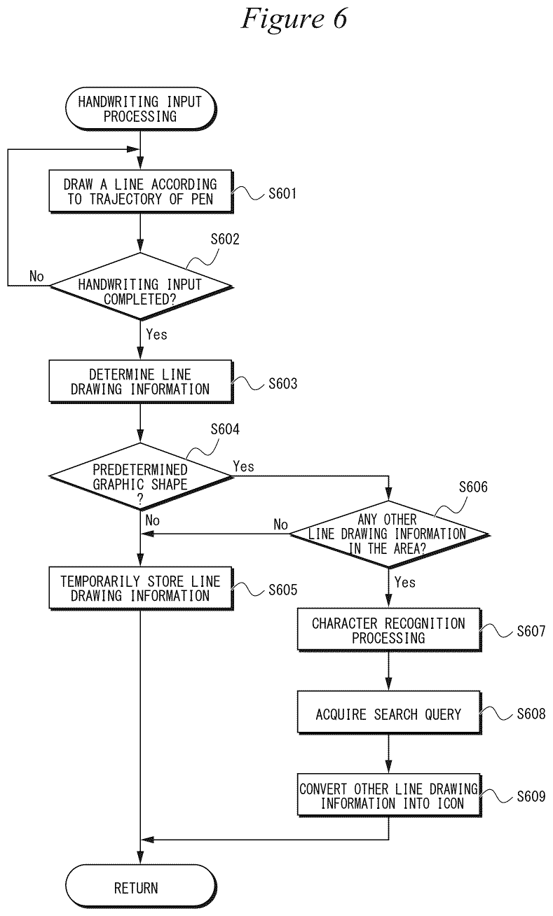

If the control unit 310 determines that the user's manipulation action is a handwriting input (S503; Yes), then the control unit 310 performs handwriting input processing according to the strokes entered (S504). The details of the handwriting input processing will be described with reference to FIG. 6. After the completion of the handwriting input processing, the control unit 310 returns to the processing in which the user's manipulation actions are monitored (S501).

On the contrary, if the control unit 310 determines that the user's manipulation action is not a handwriting input (S503; No), the control unit 310 assumes, in the present example, that the manipulation action is an invalid input and returns to the processing in which the user's manipulation actions are monitored (S501). For example, a very short single stroke may be considered an invalid input.

On the other hand, if the control unit 310 determines that there is a selectable object at the position on the screen corresponding to the user's manipulation action (S502; Yes), the control unit 310 discerns the manipulation action (S505) and performs processing corresponding to such manipulation action. Examples of manipulation actions may include: a “tap”, which is an operation of lightly tapping on an object on the screen with a pen; a “drag”, which is an operation of capturing an object on the screen and dragging it with a pen; a “flick”, which is an operation of quickly sweeping an object on the screen with a pen; and a “slide” and/or “swipe” that move a pen in a predetermined direction by touching an empty area on the screen with a pen, but the manipulation actions are not limited to the above. In the present disclosure, processing based on a tap, a drag, and a flick, among the manipulation actions, will be described. In the following examples, the manipulation action on the selectable object on the screen corresponds to the second manipulation action or the third manipulation action.

Specifically, the control unit 310 performs the processing of selecting an object if the user's manipulation action is a tap (S506). In addition, if the user's manipulation action is a drag, the control unit 310 performs the processing of moving an object according to the drag (S507). Further, if the user's manipulation action is a flick, the control unit 310 performs the processing of removing an object from the screen by flicking the object out of the screen in response to the flick (S508). The details of these processing will be described with reference to FIGS. 6 to 11 respectively. After the completion of each processing, the control unit 310 returns to the processing in which the user's manipulation actions are monitored (S501).

FIG. 6 is a flowchart showing an example of processing a handwriting input performed by an information communication terminal device according to an embodiment of the present invention. FIG. 6 shows the details of the handwriting input processing (S504) shown in FIG. 5.

Specifically, as shown in FIG. 6, the control unit 310 performs control such that lines are drawn on the screen displayed on the touch panel 36a according to the input signal output by the touch panel 36a in response to the stroke trajectory made by the contact movement of the user's pen (S601). The control unit 310 then determines whether the user's handwriting input has been completed (S602). For example, the control unit 310 may determine that the handwriting input has been completed if it does not detect the next stroke within a predetermined period of time after the pen leaves the touch panel 36a after a stroke. The control unit 310 continues to draw a line if it determines that the user's handwriting input has not been completed (S602; No).

On the other hand, if the control unit 310 determines that the user's handwriting input has been completed (S602; Yes), the control unit 310 defines the line drawing data from the user's handwriting input (S603). The line drawing data may be vector data of a set of multiple lines (regardless of whether they are straight lines or curved lines).

The control unit 310 then determines whether the defined line drawing data represents a predetermined graphic shape (S604). In the present example, the predetermined graphic shape may be a closed graphic shape. The closed graphic shape is not limited to the shape in which the line is completely closed, but also includes a shape that can be regarded as a practically closed shape even if part of the line is disconnected. In addition, the predetermined graphic shape may be limited to a closed graphic shape consisting of simple curve lines, such as a circle or an ellipse. Alternatively, the control unit 310 may determine whether the line drawing data represents a predetermined geometric line drawing (e.g., an underline, check mark, etc.) instead of a closed graphic.

If the control unit 310 determines that the defined line drawing data does not indicate the predetermined graphic shape (S604; No), the control unit 310 temporarily stores the line drawing data in the screen data storage unit 322 (S605). Specifically, the line drawing data temporarily stored in the screen data storage unit 322 may become other line drawing data (objects) described above that are selected by the subsequent user's manipulation action.

If, on the other hand, the control unit 310 determines that the defined line drawing data represents the predetermined graphic shape (S604; Yes), then the control unit 310 determines whether any other line drawing data (line drawing data to be selected) is present within the area (range) enclosed by the predetermined graphic shape (S606). In other words, the control unit 310 determines whether the user has intentionally selected another line drawing data present on the screen. The “another line drawing data” referred to here may be the line drawing data that has been previously handwritten by the user. The area enclosed by the predetermined graphic shape includes an area that can be considered to be practically enclosed. In addition, the control unit 310 may determine that another line drawing data is present as long as at least part of such another line drawing data is included in the area. Put another way, the control unit 310 may determine that another line drawing data is present if the user draws a closed graphic such that it encloses at least part of the area indicated by the line drawing data that the user has previously handwritten and displayed on the screen in order to select such line drawing data. In this way, the manipulation action of drawing the line drawing data that indicates a predetermined graphic shape in order to select another line drawing data corresponds to the first manipulation action.

If the control unit 310 determines that no line drawing data to be selected is present in the area enclosed by the predetermined graphic shape (S606; No), the control unit 310 considers that the defined line drawing data is not data which has been handwritten by the user for selection, and temporarily stores such line drawing data in the screen data storage unit 322 (S605). For example, this may allow for the storage of the line drawing data, such as a memo written onto the touch panel 36a by the user. Such line drawing data may become part of the screen data.

On the other hand, if the control unit 310 determines that another line drawing data is present in the area enclosed by the predetermined graphic shape (S606; Yes), the character recognition unit 3121 performs character recognition on such another line drawing data in the area (S607). Specifically, the character recognition unit 3121 performs character recognition processing on the line drawing data to generate text data. The search result acquisition unit 314 then acquires the generated text data as a search query (S608). As will be described below, the search request transmission unit 313 transmits a search request based on the acquired search query to the search server 20, and the search result acquisition unit 314 acquires the search results (search result images) thereof from the search server 20.

The display control unit 315 then converts the generated text data into, for example, an icon indicating the character-recognized text (S609). The display control unit 315 performs control such that the converted icon is displayed on the screen instead of the handwritten line drawing data. Alternatively, the generated text data may be treated as text data as it is, without being converted to icons.

As described above, if the user makes a handwriting input to a free space on the screen of the touch panel 36a, the information communication terminal device 30 determines whether it is an input of a text or a selection of the text that has already been entered. In addition, if the information communication terminal device 30 determines that the handwriting input is an input of a text, the device 30 temporarily stores the line drawing data indicating the text. Further, if the information communication terminal device 30 determines that it is a selection of line drawing data indicating the already entered line drawing data, the information communication terminal device 30 performs character recognition processing on the line drawing data, converts it into text data, and acquires this as a search query.

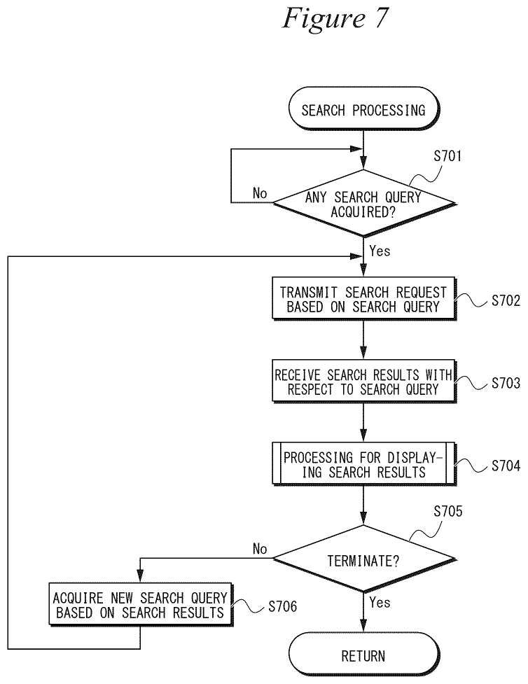

FIG. 7 is a flowchart showing an example of search processing performed by an information communication terminal device according to an embodiment of the present invention. This processing starts when the search query is acquired by the search query acquisition unit 311. For example, the control unit 310 may execute the search processing in response to the acquisition of the search query in a separate thread or process. As a result, as will be described later, a new search query is acquired from the search results responding to the search request by the acquisition of the first search query, and further search processing is carried out in a chain or derivative manner.

Specifically, as shown in FIG. 7, the control unit 310 monitors whether any search query is acquired by the search query acquisition unit 311 (S701). If the control unit 310 determines that the search query has been acquired (S701; Yes), the search request transmission unit 313 generates a search request based on the search query and transmits it to the search server 20 (S702). When the search server 20 receives the search request from the information communication terminal device 30, the search server 20 extracts the relevant resources by referring to the database 24 and performing a search based on the search query contained in the search request, and transmits the resources to the information communication terminal device 30 as the search results. The search results contain one or more search result images. When the search server 20 extracts the search results, the search server 20 may transmit the search results to the information communication terminal device 30 by a predetermined number in response to a fetch request from the search result acquisition unit 314 of the information communication terminal device 30.

As a result, the search result acquisition unit 314 receives the search results transmitted from the search server 20 in response to the search request (S703). For example, the search result acquisition unit 314 may transmit a fetch request with respect to the multiple search result images searched and extracted by the search server 20, divides them into a predetermined number, and acquires them as search results.

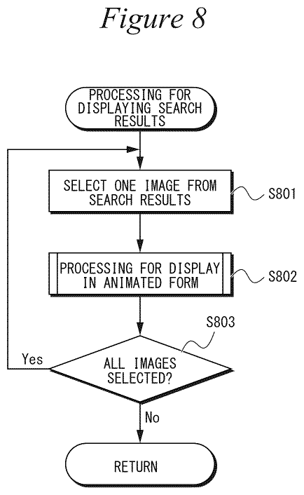

The display control unit 315 then performs processing for displaying the acquired search results (search result images) on the screen (S704). The details of the processing for displaying the search results will be described with reference to FIG. 8. Schematically speaking, the control unit 310 performs control such that each of the multiple search result images is displayed in sequence in animated form at arbitrary positions on the screen with a visually recognizable time difference. Examples of a mode of the display in animated form may include: a mode in which the search result image is gradually completed visually; a mode in which the search result image is visually expressed in perspective on the screen; a mode in which the search result image is visually enhanced; and other modes, but the mode is not limited to the above.

After completing the display of the search results by the display control unit 315, the control unit 310 determines whether to terminate the search processing (S705). For example, if the user chooses to pause the search, the control unit 310 terminates the search processing. On the other hand, if the control unit 310 determines to continue with the search processing (S705; No), a new search query is acquired based on the search results by the search query acquisition unit 311 (S706). For example, the search query acquisition unit 311 may acquire a search query based on the metadata associated with the search result images. When a new search query is acquired by the search query acquisition unit 311, the control unit 310 returns to the processing in S702 and continues with the search processing. Specifically, the search request transmission unit 313 transmits a search request based on the newly acquired search query to the search server 20, acquires the search results responding to such search request, and displays them on the screen. In this way, a new search query is acquired from the search results responding to the search request arising from the acquisition of the first search query, and further search processing is carried out in a chain or derivative manner.

FIG. 8 is a flowchart showing an example of processing for displaying the search results performed by an information communication terminal device according to an embodiment of the present invention. FIG. 8 shows the details of the handwriting input processing (S704) shown in FIG. 7.

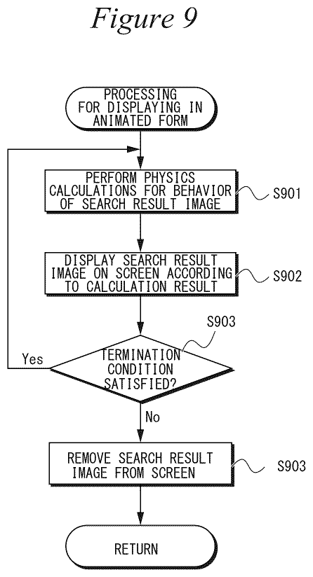

As shown in FIG. 8, when the search result acquisition unit 314 acquires the search result images in bulk or in segments from the search server 20, the display control unit 315 selects one search result image from among the search result images (S801). The display control unit 315 then starts the processing for displaying the selected search result image in animated from (S802). The display control unit 315 may execute the processing for displaying in animated form in a separate thread, and the like. As a result, the selected search result image is displayed in animated form as an object in the virtual space gradually appearing in sequence with a visually recognizable time difference. The details of the processing for displaying in animated form will be described with reference to FIG. 9. At this time, the display control unit 315 may perform control such that at least part of the metadata associated with the search result images is displayed in association with the object displayed in animated form.

Next, the display control unit 315 determines whether all of the acquired search result images have been selected (S803). If the display control unit 315 determines that not all of the acquired search images have been selected (S803; No), the display control unit 315 returns to the processing in S801. On the other hand, if the display control unit 315 determines that all of the acquired search images have been selected (S803; Yes), the display control unit 315 terminates the processing for displaying the search results.

FIG. 9 is a flowchart showing an example of processing for displaying in animated form performed by an information communication terminal device according to an embodiment of the present invention. This processing shows the details of the processing for displaying in animated form (S802) shown in FIG. 8.

As shown in FIG. 9, the display control unit 315 simulates the behavior of each search result image in the virtual space by performing physics calculations using the physics engine 3151 based on predetermined physical parameters (e.g., mass, velocity, external forces, airflow, etc.) (S901). For example, the display control unit 315 may perform simulation as if each search result image were floating in the virtual space. In this case, the display control unit 315 may also perform physics calculations such that the fluctuation of a search result image floating in the virtual space is a 1/f fluctuation.

Next, the display control unit 315 performs control such that the search result image is displayed in animated form on the screen representing the virtual space according to the results of such physics calculations (S902). Specifically, the display control unit 315 generates screen data according to the results of physics calculations and outputs this data to the user interface unit 330. As a result, the search result image may be displayed as if it were floating in the screen representing the virtual space. At this time, the display control unit 315 may perform control such that at least part of the metadata associated with the search result images is displayed in association with the object displayed in animated form.

The display control unit 315 then determines whether the display of the search result image in animated form satisfies a predetermined termination condition (S903). The predetermined termination condition may be whether the display of the search result image in animated form has elapsed a predetermined time (e.g., 10 seconds) from the start.

If the display control unit 315 determines that the display of the search result image in animated form fails to satisfy the predetermined termination condition (S903; No), the display control unit 315 continues with the display of the above-described animation based on the simulation. On the other hand, if the display control unit 315 determines that the display of the search result image in animated form satisfies the predetermined termination condition (S903; Yes), the display control unit 315 controls the display in animated form as if the search result image disappears spontaneously (fades out) to remove the search result image from the screen (S904).

As described above, the information communication terminal device 30 performs control so as to acquire a search query based on the handwriting input made by the user, to make a search request to the search server 20, to acquire the search results (search result images) responding to the request, and to display the search result images in animated form on the screen representing the virtual space. In addition, the information communication terminal device 30 acquires a new query based on the search results, and then further acquires the search results from the search server 20. As a result, because various search queries are developed starting from the first handwriting input, searches can be performed without being bounded to a single point of view, and the evocation and activation of user's thoughts can be promoted.

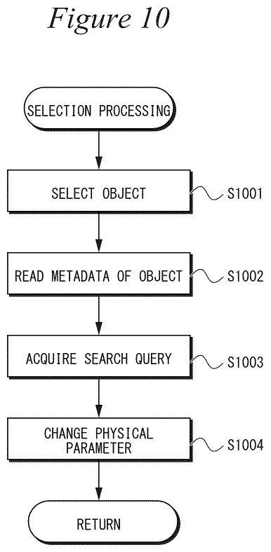

FIG. 10 is a flowchart showing an example of processing for selecting an object performed by an information communication terminal device according to an embodiment of the present invention. FIG. 10 shows the details of the processing for selecting an object (S506) shown in FIG. 5.

Specifically, as shown in FIG. 5, if the user taps on a selectable object on the screen as a manipulation action, the control unit 310 selects the object corresponding to the tapped position as an object of interest (S1001). Here, the object is assumed to be a search result image or icon.

The control unit 310 then reads the metadata associated with the selected object of interest (S1002) and the search query acquisition unit 311 sets the read metadata as a search query (S1003). This allows the information communication terminal device 30 to transmit a search request based on the set search query to the search server 20, and acquire the search results transmitted from the search server 20 in response to the search request.

The display control unit 315 then changes the value of a predetermined physical parameter for the display in animated form (S1003). The display control unit 315 may change the value of a predetermined physical parameter so that the speed of movement of objects in the virtual space is increased. A change in the value of a predetermined physical parameter may affect all objects in the virtual space. This increases the speed of movement of objects in the virtual space compared to before the selection, giving the user the feeling that the entire screen is activated. It should be noted that the display control unit 315 may reset to the original value after a predetermined period of time has elapsed after changing the value of the predetermined physical parameter to increase the speed of movement of the objects.

In the case where a search result image is selected as an object of interest by a user tap, the control unit 310 may perform control so as to store such search result image in the asset folder such that it can be distinguished from other search result images. Alternatively, in the case where the user's manipulation action is a double tap on the search result image, the control unit 310 may perform control so as to store such search result image in the asset folder.

As described above, if the user selects an object on the screen by tapping on it, the information communication terminal device 30 can acquire a new search query based on the selected object and acquire further search results. In addition, by using the user tap as a trigger, the information communication terminal device 30 can control the display in animated form such that the speed of movement of the objects on the screen is increased to create a rendering from a calm state to an activated state and thereby promote the evocation and activation of user's thoughts.

It should be noted that, as will be described below, the processing for selecting an object may include a processing step for confirmation by the user.

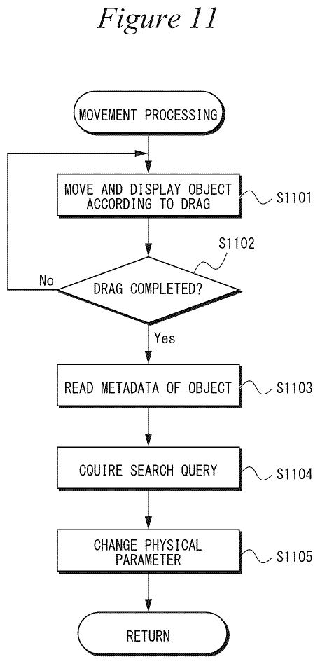

FIG. 11 is a flowchart showing an example of processing for moving an object performed by an information communication terminal device according to an embodiment of the present invention. FIG. 11 shows the details of the processing for moving an object (S507) shown in FIG. 5.

Specifically, as shown in FIG. 5, if the user drags a selectable object on the screen as a manipulation action, the display control unit 315 selects the object corresponding to the starting position of the drag as an object of interest and controls the display in animated form such that the object of interest moves according to the movement of the drag (S1101). The control unit 310 also monitors whether the drag has been completed (S1102). Specifically, the user can move the object from its current position to a second position by a drag.

If the control unit 310 determines that the drag has been completed (S1102; Yes), the control unit 310 reads, as described above, the metadata associated with the dragged object of interest (S1103) and the search query acquisition unit 311 sets the read metadata as a search query (S1104). This allows the information communication terminal device 30 to transmit a search request based on the set search query to the search server 20, and acquire the search results transmitted from the search server 20 in response to the search request. The display control unit 315 then changes the value of a predetermined physical parameter for the display in animated form (S1105). This increases the speed of movement of objects in the virtual space compared to before the selection, giving the user the feeling that the entire screen is activated. It should be noted that the display control unit 315 may reset to the original value after a predetermined period of time has elapsed after changing the value of the predetermined physical parameter to increase the speed of movement of the objects.

If the user drags the search result image onto another icon (e.g., an icon indicating an asset folder), the control unit 310 may perform control so as to store the search result image in the asset folder.

As described above, the user can move the object of interest to anywhere on the screen by dragging such object. The information communication terminal device 30 can acquire a search query based on the object on which the user's manipulation action has been made and acquire further search results. In addition, by using the user drag as a trigger, the information communication terminal device 30 can increase the speed of movement of the objects on the screen to create a rendering from a calm state to an activated state and thereby promote the evocation and activation of user's thoughts.

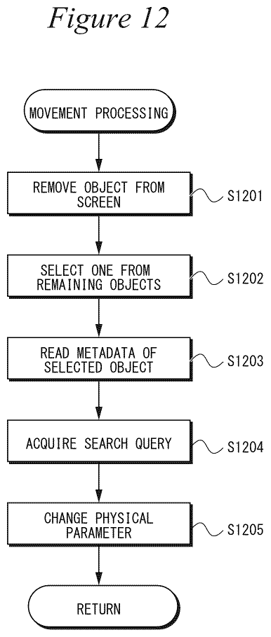

FIG. 12 is a flowchart showing an example of processing for removing an object performed by an information communication terminal device according to an embodiment of the present invention. FIG. 12 shows the details of the processing for removing an object (S508) shown in FIG. 5.

Specifically, as shown in FIG. 5, if the user flicks a selectable object on the screen as a manipulation action, the control unit 310 selects the object corresponding to the position where the flick was performed as an object of no interest (an object to be excluded) and, in response to such selection, the control unit 310 controls the display in animated form such that the object of no interest is flicked out of the screen (S1201).

The control unit 310 then selects at least one of the remaining objects on the screen that were not selected as the object of no interest (S1202). For example, the control unit 310 may select one object at random from among the objects on the screen. In this case, the control unit 310 may select one object from among the objects that have not been set as a search query in the past.

The control unit 310 then reads the metadata associated with the selected object (S1203) and the search query acquisition unit 311 sets the read metadata as a search query (S1204). This allows the information communication terminal device 30 to transmit a search request based on the set search query to the search server 20, and acquire the search results transmitted from the search server 20 in response to the search request. The display control unit 315 then changes the value of a predetermined physical parameter for the display in animated form (S1205). This increases the speed of movement of objects in the virtual space compared to before the selection, giving the user the feeling that the entire screen is activated. It should be noted that the display control unit 315 may reset to the original value after a predetermined period of time has elapsed after changing the value of the predetermined physical parameter to increase the speed of movement of the object.

As described above, the user can remove the objects with respect to which the user determined to be unnecessary by a flick in such a manner that they are flicked out of the screen. The information communication terminal device 30 can acquire a search query based on the object which has not been removed by the user and acquire further search results. In addition, by the drag performed by the user to increase the speed of movement of the objects on the screen, the information communication terminal device 30 can create a rendering from a calm state to an activated state and thereby promote the evocation and activation of user's thoughts.

### Examples

Next, specific examples of the operations caused by the user's manipulation actions on the information communication terminal device 30 configured as above will be described.

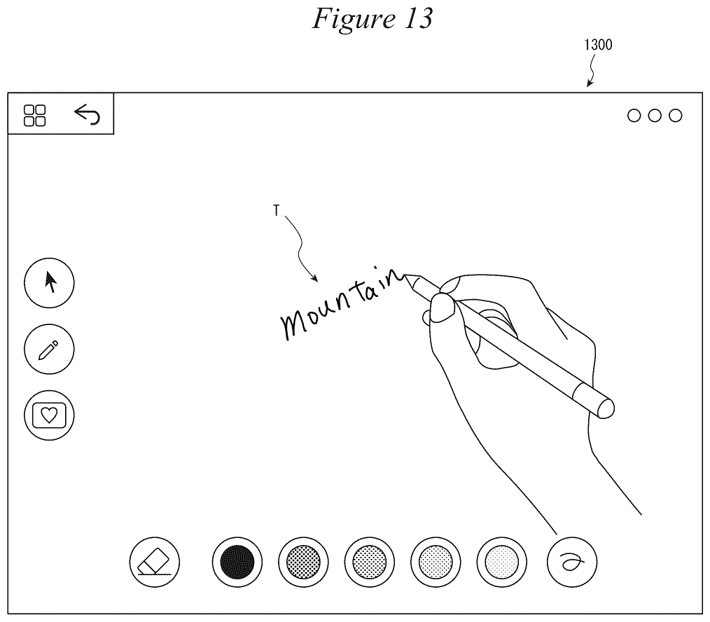

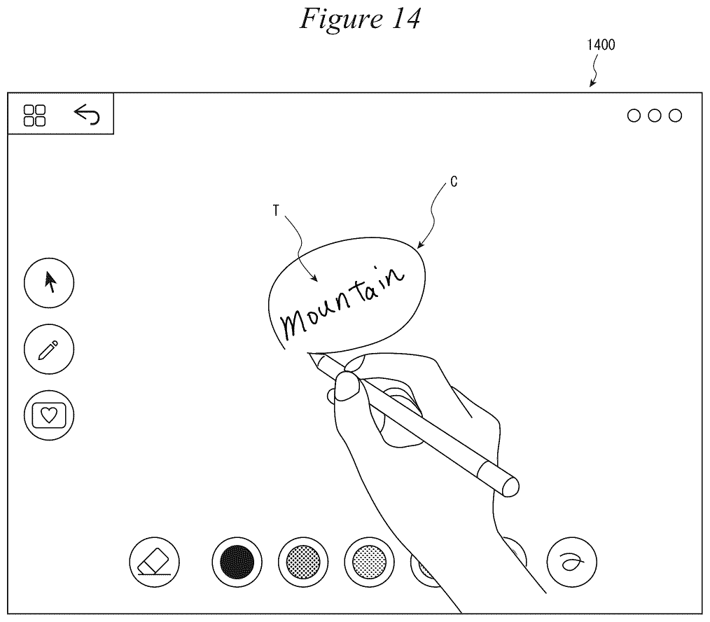

Specifically, as shown in FIG. 13, suppose that a user has handwritten a keyword or text (word) T (e.g., “mountain”) on the screen 1300 displayed on the touch panel 36a. As described above, the information communication terminal device 30 internally treats the handwritten “entities” as line drawing data (e.g., vector data) at this point. As shown in FIG. 14, the user then draws a circle C to enclose the handwritten text T (“mountain”) on the screen 1400.

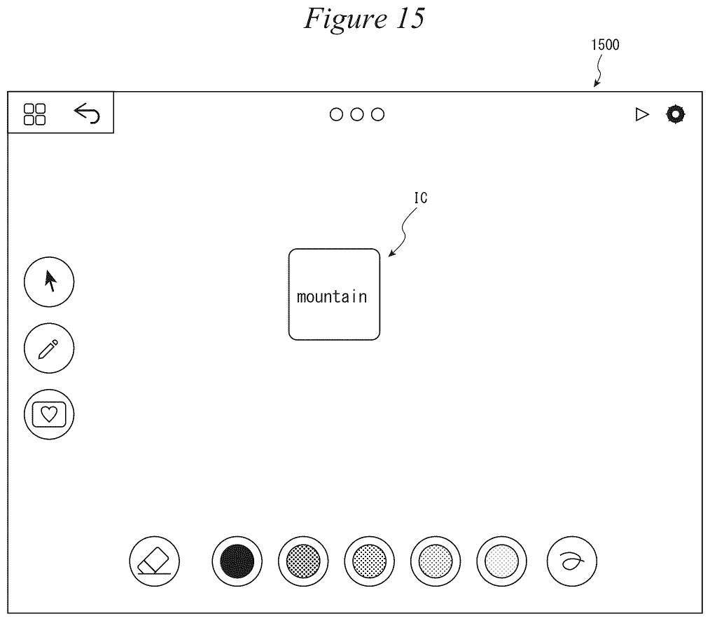

In response, the information communication terminal device 30 performs character recognition processing for the line drawing data corresponding to the “mountain” enclosed in the circle C, and generates text data corresponding to the “mountain” and acquires this as a search query. At this time, the information communication terminal device 30 may convert the character-recognized text into an icon or tile, as in the screen 1500 shown in FIG. 15, in order to inform the user that the character recognition of the line drawing data has been successful. Alternatively, although not shown, the word that is character-recognized may be displayed in text data (in predetermined font characters). The information communication terminal device 30 then generates a search request based on the acquired search query and transmits it to the search server 20. In response, the search server 20 refers to the database 24, extracts one or more search result images, and transmits them as search results to the information communication terminal device 30.

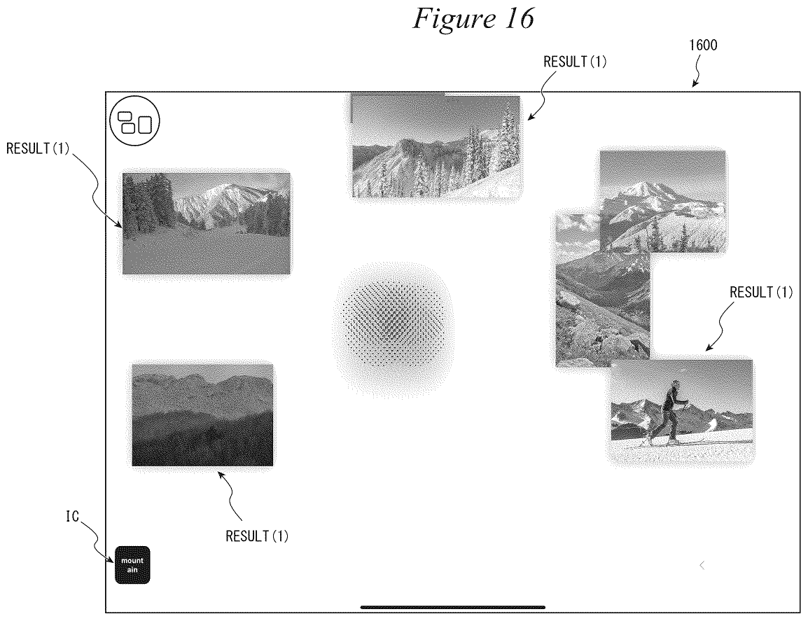

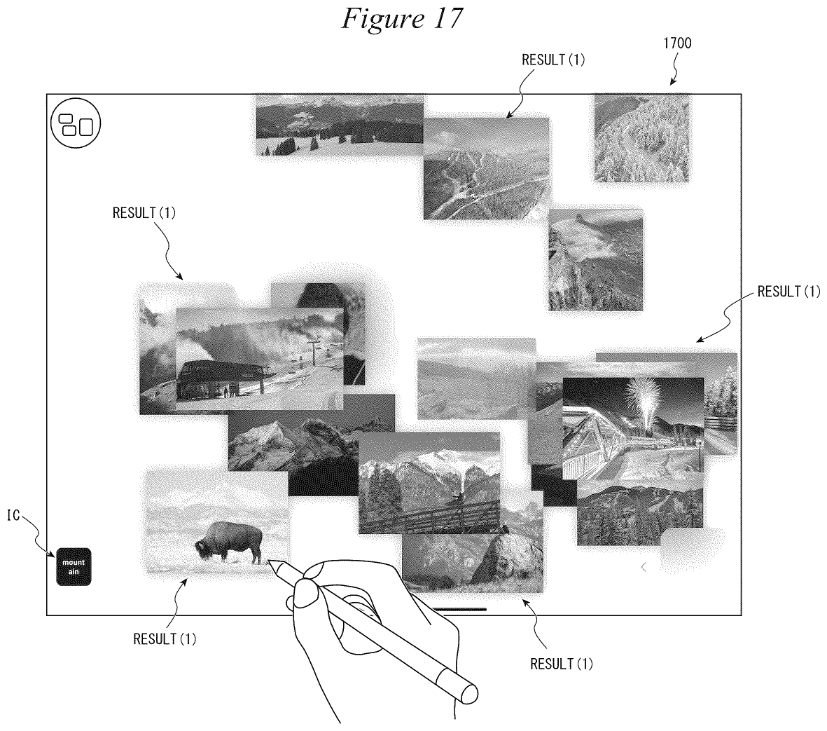

When the information communication terminal device 30 acquires the search results transmitted from the search server 20, the information communication terminal device 30 may perform control so as to display in animated form multiple search result images RESULT (1) contained in the search results such that they gradually appear at arbitrary positions (e.g., random positions) on the screen 1600 in sequence as shown in FIG. 16 as if they were floating in the virtual space. FIG. 17 shows the state (the screen 1700) in which some time has elapsed from the state on the screen 1600 shown in FIG. 16. FIG. 17 shows that the search results for the keyword “mountain” include an image of a mountain with a “buffalo”. This is because such image may typically contain metadata such as “buffalo”. This allows the user to be provided with an evocation of an unexpected keyword, such as “buffalo”, from the keyword “mountain”.

On the screens shown in FIGS. 16 and 17 where the display in animated form is provided, the user can perform manipulations such as selecting a search result image by a tap, moving the search result image by a drag, and/or flicking the search result image out of the screen by a flick. Meanwhile, the information communication terminal device 30 can acquire a new search query and continue with the search processing while displaying the search result images in animated form.

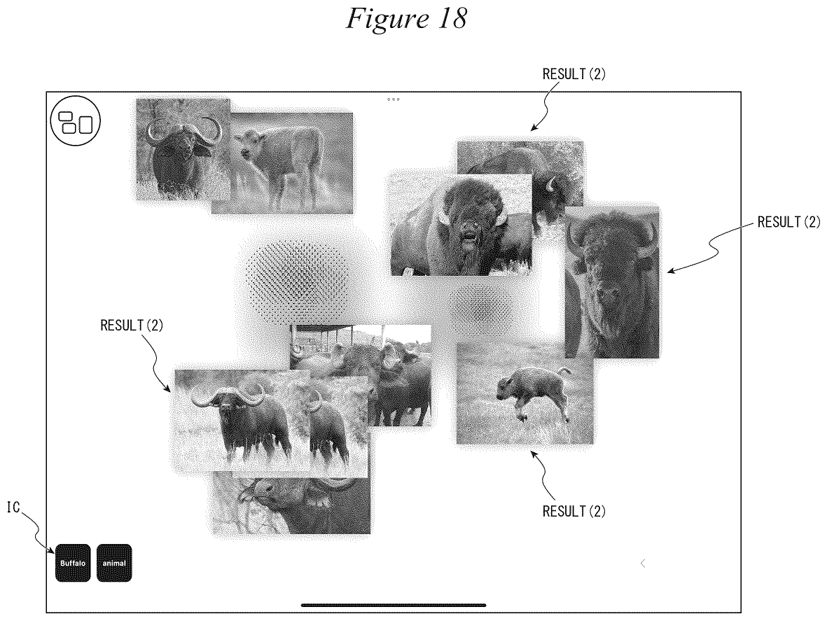

For example, suppose that the user has used a pen to tap on the search result image, in which the “buffalo” is shown, at the bottom left of the screen 1700 in FIG. 17. In response, the information communication terminal device 30 refers to the metadata associated with such search result image and acquires this as a search query. In the present example, it is assumed that the keyword “buffalo” is associated with the metadata. Therefore, the information communication terminal device 30 generates a search request with the keyword “buffalo” as a search query and transmits it to the search server 20. As a result, the information communication terminal device 30 acquires the search result images for the keyword “buffalo” transmitted from the search server 20, and may display the search result images RESULT (2) such as shown in FIG. 18 on the screen.

As described above, according to the present embodiment, in the case where a user handwrites some text on the screen of the touch panel 36a and draws a trajectory that encloses such text, the information communication terminal device 30 performs character recognition processing on the line drawing data in the area enclosed by the trajectory to convert the line drawing data into text data, acquires the converted text data as a search query, and acquires search results responding to a search request based on the acquired search query from the search server 20. Therefore, there is no need for the user to switch from a pen manipulation to a keyboard or mouse manipulation for performing Internet searches, a smooth flow of a sequence of operations can be achieved, and the user's thought process is not interrupted. Therefore, the user can materialize a seamless thought process, and evocation and activation of thoughts are thereby promoted.

In addition, according to the present embodiment, multiple search result images contained in the search results obtained in response to the search request are not displayed in a list in an aligned manner, but instead, respective search result images are displayed in animated form at arbitrary positions on the screen in sequence with a visually recognizable time difference. Therefore, the user feels comfort, and evocation and activation of user's thoughts are promoted, thereby allowing him/her to engage in more creative activities.

### Variation Example

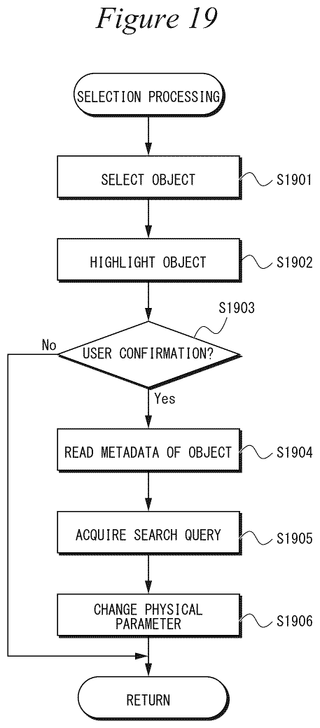

FIG. 19 is a flowchart showing another example of processing for selecting an object performed by an information communication terminal device according to an embodiment of the present invention. FIG. 19 shows a variation example of the processing for selecting an object shown in FIG. 10. Specifically, the processing for selecting an object shown in FIG. 19 differs from the processing for selecting an object shown in FIG. 10 in that a processing step related to the user's confirmation of whether to perform a search on the selected object is added.

As described above, suppose that the user has used a pent to tap on the search result image, in which the “buffalo” is shown, at the bottom left of the screen shown in FIG. 17. In response, the control unit 310 selects the object corresponding to the tapped position as an object of interest (S1901).

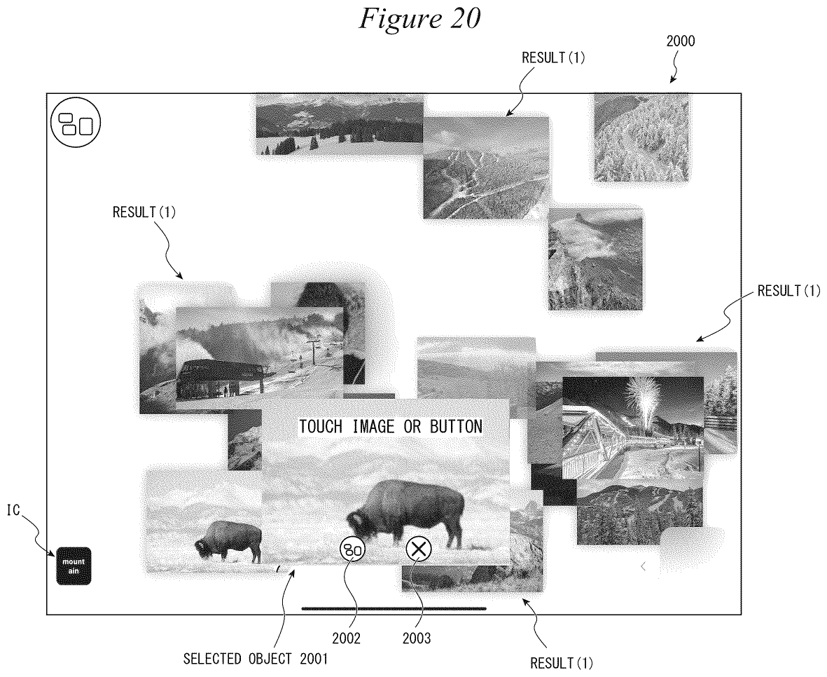

Under the control of the control unit 310, the display control unit 315 then highlights the selected object (S1902) and performs control so as to temporarily stop the display in animated form, and, under the control of the control unit 310, prompts the user to choose whether to perform a search according to the object (S1903). FIG. 20 shows an example of a screen on which the selected object is highlighted. FIG. 20 shows an example in which the selected object 2001 (i.e., the “buffalo”) is enlarged in the area roughly at the bottom center of the screen 2000. If the user wishes to perform a search on the selected object 2001, the user may touch the object 2001 itself or touch a perform button 2002, or if the user wishes to cancel, the user may touch the area other than the object 2001 or a cancel button 2003 on the screen 2000.

If the user chooses to perform a search according to the selected object (S1902; Yes), the control unit 310 reads the metadata associated with the selected object of interest (S1904). The search query acquisition unit 311 then sets the read metadata as a search query (S1905). This allows the information communication terminal device 30 to transmit a search request based on the set search query to the search server 20, and acquire the search results transmitted from the search server 20 in response to the search request.

The display control unit 315 then changes the value of a predetermined physical parameter for the display in animated form (S1903). The display control unit 315 may change the value of a predetermined physical parameter so that the speed of movement of objects in the virtual space is increased. A change in the value of a predetermined physical parameter may affect all objects in the virtual space. This increases the speed of movement of objects in the virtual space compared to before the selection, giving the user the feeling that the entire screen is activated. It should be noted that the display control unit 315 may reset to the original value after a predetermined period of time has elapsed after changing the value of the predetermined physical parameter to increase the speed of movement of the objects.

On the other hand, if the user chooses not to perform a search according to the selected object (S1903; No), the control unit 310 terminates the processing for selecting an object (S506 shown in FIG. 5).

As described above, in the case where the user selects an object by tapping on the object on the screen, the information communication terminal device 30 enlarges the object and prompts the user to confirm whether to perform a search. Therefore, it is possible to bring the behavior of the screen display closer to the user's expectation, and usability is therefore improved.

The above-described respective embodiments are illustrations for describing the present invention, and are not intended to limit the present invention only to these embodiments. The present invention may be implemented in various forms, as long as they do not deviate from the gist of the invention.

For example, the steps, actions, or functions in the method disclosed in the present specification may be implemented in parallel or in different order, unless there is no inconsistency in the results. The described steps, actions, and functions are provided as examples only and some of the steps, actions, and functions may be omitted and may be performed as one entity by being combined with each other, and other steps, actions, or functions may be added, to the extent that they do not deviate from the gist of the invention.

In addition, various embodiments are disclosed in the present specification, but specific features (technical matters) in one embodiment may be added to other embodiments with appropriate improvements, or may be replaced with specific features in such other embodiments, and such embodiments are also included in the gist of the present invention.

### List of Reference Signs

1 . . . Creation assistance system
10 . . . Communication network
20 . . . Search server
   22 . . . Search engine
   24 . . . Database
30 . . . Information communication terminal device
   31 . . . Processor module
   32 . . . Chipset
   33 . . . Memory module
   34 . . . I/O controller
   35 . . . Peripheral interface
      35a . . . I/O interface
      35b . . . Communication interface
   36 . . . I/O devices
      36a . . . Touch panel
      36b . . . Speaker
      36C . . . Camera
   310 . . . Control unit
      311 . . . Search query acquisition unit
      312 . . . Recognition unit
      313 . . . Search request transmission unit
      314 . . . Search result acquisition unit
      315 . . . Display control unit
   320 . . . Storage unit
      321 . . . Search result storage unit
      322 . . . Screen data storage unit
      323 . . . Operation history storage unit
   330 . . . User interface unit
   340 . . . Communication interface unit
40 . . . Creation assistance server

1. An information communication terminal device that is communicably connectable to a search server, comprising:
a user interface unit that includes a touch panel;
a search query acquisition unit that acquires a search query;
a search result acquisition unit that acquires search results containing multiple search result images transmitted from the search server in response to the search query; and
a display control unit that performs control for displaying each of the multiple search result images contained in the search results on a screen that represents a virtual space on the touch panel,
wherein the display control unit performs control such that each of the multiple search result images is displayed in animated form in sequence with a visually recognizable time difference, each of multiple search result images being gradually appearing from a first position determined with respect to the search result image within the screen on the touch panel.

2. The information communication terminal device according to claim 1, further comprising a recognition unit that performs first recognition processing based on line drawing data handwritten on the screen of the touch panel, wherein the search query acquisition unit acquires a text recognized by the recognition unit as the search query.

3. The information communication terminal device according to claim 2, wherein the recognition unit starts performing the first recognition processing in response to a user's first manipulation action to the line drawing data on the screen of the touch panel.

4. The information communication terminal device according to claim 3, wherein the first manipulation action is a drawing of a line that encloses at least part of an area indicated by the line drawing data on the screen of the touch panel.

5. The information communication terminal device according to claim 2, wherein
the recognition unit is configured to perform second recognition processing on image data to generate object information, and
the search query acquisition unit acquires the search query based on the generated object information.

6. (canceled)

7. The information communication terminal device according to claim 1, wherein the mode of the display in animated form is at least one of: a mode in which the search result image is gradually completed visually; a mode in which the search result image is visually expressed in perspective; and a mode in which the search result image is visually enhanced.

8. The information communication terminal device according to claim 1, wherein the display control unit determines the first position on the screen for each of the multiple search result images and performs control such that each search result image is displayed at the determined first position.

9. The information communication terminal device according to claim 8, wherein the first positions for the respective search result images are not geometrically aligned with each other.

10. The information communication terminal device according to claim 8, wherein the display control unit randomly determines the first position for each search result image.

11. The information communication terminal device according to claim 1, wherein the display control unit performs control of the display in animated form such that the displayed search result image gradually disappears after a predetermined period of time has elapsed.

12. The information communication terminal device according to claim 1, wherein the display control unit performs control, in response to the user's second manipulation action on at least one search result image of interest from among the multiple search result images on the screen of the touch panel, so as to move the at least one search result image of interest to a second position on the screen.

13. The information communication terminal device according to claim 1, wherein the search query acquisition unit acquires, in response to the user's second manipulation action on at least one search result image of interest from among the multiple search result images on the screen of the touch panel, a new search query based on metadata associated with the at least one search result image of interest.

14. The information communication terminal device according to claim 1, wherein the display control unit performs control, in response to the user's second manipulation action on at least one search result image of interest from among the multiple search result images on the screen of the touch panel, so as to highlight the at least one search result image of interest.

15. The information communication terminal device according to claim 14, wherein the search query acquisition unit acquires a new search query based on metadata associated with the at least one search result image of interest, if the user chooses to perform a search.

16. The information communication terminal device according to claim 12, wherein the display control unit performs control, in response to the second manipulation action, such that the display in animated form is achieved in which the speed with which each of the multiple search result images gradually appears is increased.

17. The information communication terminal device according to claim 1, wherein the display control unit performs control, in response to the user's third manipulation action on at least one search result image of no interest from among the multiple search result images on the screen of the touch panel, so as to remove the at least one search result image of no interest from the screen.

18. The information communication terminal device according to claim 17, wherein the search query acquisition unit acquires, in response to the third manipulation action, a new search query based on metadata associated with some search result images devoid of the at least one search result image of no interest from among the multiple search result images.

19. A method of displaying search results by an information communication terminal device communicably connectable to a search server, the method comprising:
acquiring a search query from a user's input to a touch panel of the information communication terminal device;
in response to the search query, acquiring search results containing multiple search result images transmitted from the search server; and
performing control for displaying each of the multiple search result images contained in the search results on a screen representing a virtual space on the touch panel of the information communication terminal device, wherein
performing control includes performing control to display each of the multiple search result images in animated form in sequence with a visually recognizable time difference, each of multiple search result images being gradually appearing from a first position determined with respect to the search result image within the screen on the touch panel.

20. (canceled)

21. A product comprising a non-transitory computer-readable medium storing computer program for causing an information communication terminal device to implement a method for displaying search results transmitted from a search server in response to a search query,
the method comprising:
acquiring the search query from a user's input to a touch panel of the information communication terminal device;
in response to the search query, acquiring search results containing multiple search result images transmitted from the search server; and
performing display control for displaying each of the multiple search result images contained in the search results on a screen representing a virtual space on the touch panel,
wherein performing display control includes performing control so as to display each of the multiple search result images in animated form in sequence with a visually recognizable time difference, each of multiple search result images being gradually appearing from a first position determined with respect to the search result image within the screen on the touch panel.
